(19) United States
(12) Patent Application Publication
(10) Pub. No.: US 2012/0119459 A1
(43) Pub. Date: May 17, 2012

(54) MULTI-USE CART

(76) Inventor: Stephen D. Hanson, Homewood, CA (US)

(21) Appl. No.: 13/387,100

(22) PCT Filed: Jul. 27, 2010
(86) PCT No.: PCT/US10/43443

§ 371 Date: Jan. 25, 2012

(30) Foreign Application Priority Data
Jul. 27, 2009 (US) 61228884

(51) Int. Cl. B62B 1/00

(52) U.S. Cl. 280/47.17

(57) ABSTRACT

A multi-use cart having multiple possible configurations and multiple possible uses.

### CLAIM OF PRIORITY

The present application claims priority to Provisional Patent Application No. 61/228,884, filed Jul. 27, 2009, the complete contents of which are hereby incorporated by reference herein.

### BACKGROUND

1. Field of the Invention

The present invention relates to the field of material handling apparatuses, specifically multi-function carts having multiple configurations for use with home, office, or commercial tasks.

2. Background

In our modern society, people are constantly searching for tools or devices that can make everyday tasks easier. Currently, there are a wide variety of such devices, from simple devices like paper towel holders to more complex systems like washing machines. But, for tasks requiring the transportation of items, whether for home, office or commercial use, usually a separate tool is needed for each task. For example, when hauling lumber from a truck to a work site, one may need a cart with raised lumber supports. If that same person later desires to move a large piece of furniture, he or she cannot use the lumber cart, but instead needs to have a dolly or hand truck. When the same person subsequently needs to transport dirt or mulch while gardening, the lumber cart and dolly cannot perform this function and a wheelbarrow is needed. Although devices exist to perform these functions, storing each one can be burdensome, expensive, and can take up valued space in one's home or place of business.

What is needed is a multi-use cart that can be configured to accommodate multiple tasks. Configurations can include a wheelbarrow, stroller, kitchen cart, and/or hand truck. The cart should be easy to use and clean, and sturdy enough to hold heavy items. In some embodiments, the cart should have multiple swivel wheels to allow for easy manipulation of the cart. The cart should also have multiple handle options for ergonomically accommodating persons of varying stature. Additional accessories should be available so that a user can expand the cart's scope of use and customize the cart to his or her liking.

### BRIEF DESCRIPTION OF THE DRAWINGS

FIG. 1 depicts a side view of one embodiment of the present device, with a back plate, side plates, and handle assembly in deployed positions.

FIG. 1a depicts a rear of one embodiment of the present device detail view of side plates in a deployed position.

FIG. 1b depicts a top view of one embodiment of the present device with side plates in a stowed position.

FIG. 1c depicts a longitudinal cross-sectional view of one embodiment of the present device.

FIG. 2 depicts an embodiment of the present device, with a back plate and handle member in deployed positions, in a dolly/hand truck configuration.

FIG. 3 depicts an embodiment of the present device in a wheelbarrow configuration.

FIG. 4 depicts an embodiment of the present embodiment in a push-cart configuration.

FIG. 4a depicts a front view of the embodiment shown in FIG. 4.

FIG. 5 depicts a side view of an embodiment of the present device in a pull-cart configuration.

FIG. 5a depicts a front view of the embodiment shown in FIG. 5.

FIG. 6 depicts a side view of an embodiment of the present device in a stroller configuration.

FIG. 6a depicts a rear view of the embodiment in FIG. 6.

FIG. 7 depicts a side view of an embodiment of the present device in a car seat carrier configuration.

FIG. 8 depicts a side view of an embodiment of the present device in a kitchen/utility cart configuration.

FIG. 8a depicts a rear view of the embodiment shown in FIG. 8a.

FIG. 9 depicts a side view of an embodiment of the present device in a grill cart configuration.

### DETAILED DESCRIPTION

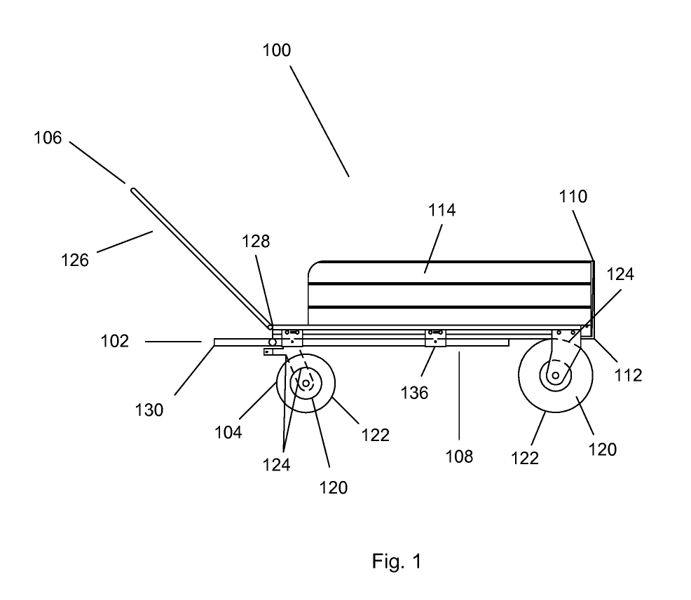

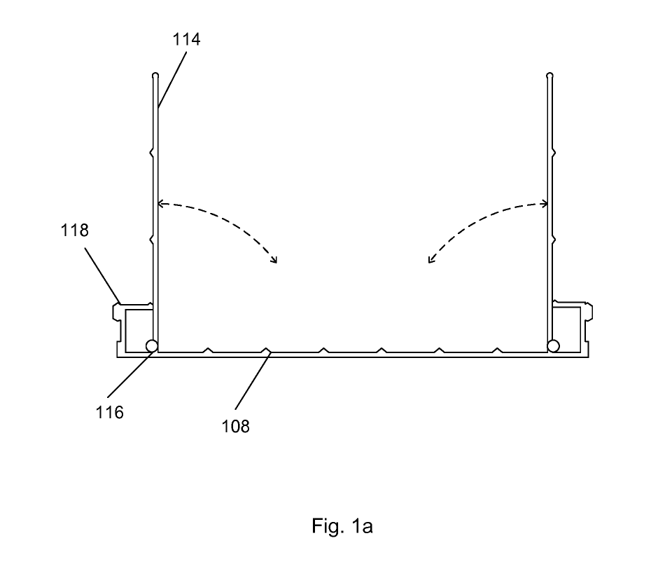

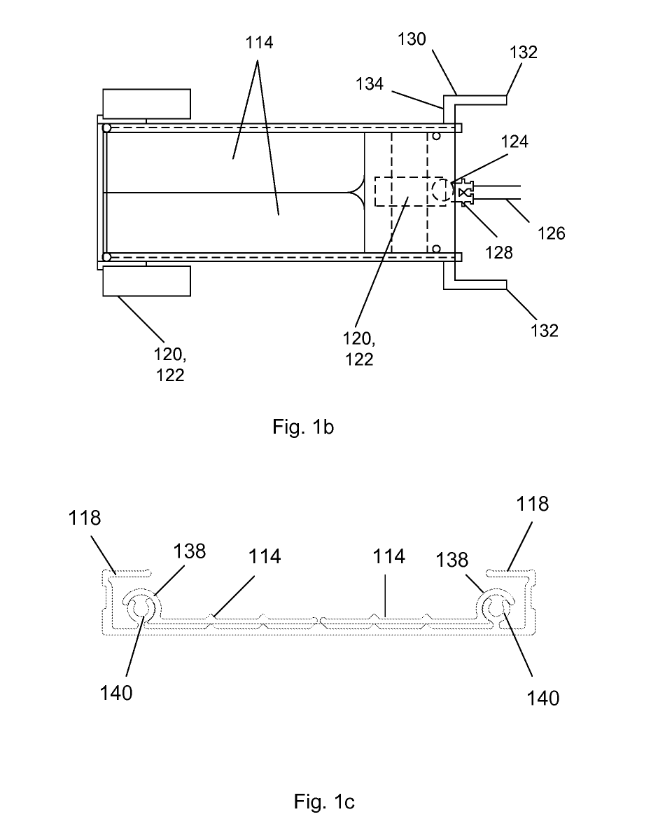

FIG. 1 depicts one embodiment of the present device. A cart 100 can comprise a frame assembly 102, at least one wheel assembly 104, and a handle assembly 106. A frame assembly 102 can be operatively coupled with both at least one wheel assembly 104 and a handle assembly 106.

A frame assembly 102 can further comprise a substantially planar base member 108, which in some embodiments can have a substantially rectangular geometry, but in other embodiments can have any other known and/or convenient geometry. In such embodiments, a substantially planar base member 108 can have a first (e.g., front) terminal edge and a second (e.g., rear) terminal edge, which can be connected by a pair of substantially parallel lateral edges. A substantially planar base member 108 can be made of aluminum, steel, wood, industrial-grade plastic, polymer, and/or any other known and/or convenient substantially rigid material. In the embodiment shown in FIG. 1, a substantially planar base member 108 can be made from a single piece of material, however in alternate embodiments a substantially planar base member 108 can further comprise multiple pieces or sections.

The surface of a substantially planar base member 108 can be substantially smooth, ridged, textured, or have any other known and/or convenient surface characteristics. In some embodiments, a substantially planar base member 108 can have non-slip properties via protrusions or other irregularities in its surface, or via a non-slip coating. In some embodiments, a substantially planar base member 108 can have insulating properties to minimize heat transfer between itself and other items with which it may be placed in contact, such as but not limited to food items, plants, and children. Insulating properties can be inherent in the material of a substantially planar base member 108, or can be accomplished via a coating on one or more surfaces of a substantially planar base member 108.

In some embodiments, a lateral portion of a back plate 110 can be connected with and/or adjacent to the second terminal edge of a substantially planar base member 108. In some embodiments, this can be a pivotal connection via a hinge mechanism 112 or any other known and/or convenient device. In the embodiment shown in FIG. 1, a hinge mechanism can comprise a pin and brackets, in which a pin can extend substantially along the entire length of a back plate 110 and a second terminal edge of a substantially planar base member 108. However, in other embodiments, a hinge mechanism 112 can extend partially along the length of a back plate 110 and a second terminal edge of a substantially planar base member 108. In other embodiments, a substantially planar member can be removably connected to a substantially planar base member 108 via a friction fit, tongue-in-groove, or any other known and/or convenient configuration/connection mechanism.

As shown in the embodiment of FIG. 1, a back plate 110 can have a substantially ninety-degree bend in its lower lateral edge that is proximal to the second terminal edge of a substantially planar base member 108. When a back plate 110 is in a deployed position, this bend can help to orient a back plate 110 substantially perpendicular to a substantially planar base member 108. In some embodiments, a back plate 110 can fold down such that it can lie substantially parallel to the top surface of a substantially planar base member 108 when in a stowed position.

As shown in FIG. 1, an edge of least one side plate 114 can be connected along a lateral edge of a substantially planar base member 108. In some embodiments, this can be a pivotal connection via a hinge or any other known and/or convenient connection mechanism. In other embodiments, a side plate 114 can be removably connected to a substantially planar base member 108 via a friction fit, tongue-in-groove, or any other known and/or convenient configuration/connection mechanism. In some embodiments, a side plate 114 can extend along a substantial portion of the length of the substantially planar base member 108. However in alternate embodiments, the side plate 114 can extend for any know and/or convenient length of the substantially planar base member 108 and/or can be absent.

As shown in FIG. 1a, in some embodiments, a lateral edge of a side plate 114 can be pivotally connected to a lateral side of the top surface of the substantially planar base member 108 via a ball hinge 116 and/or any other known and/or convenient rotating and/or pivotally coupling mechanism. As shown in FIG. 1a, a substantially planar base member 108 can further comprise a rail 118 along a lateral edge of a substantially planar base member 108. When in a deployed position, a side plate 114 can rest against a rail 118, or in some embodiments be locked into place via a pin, clasp, latch, or any other known and/or convenient mechanism. In a deployed position, a side plate 114 can be substantially perpendicular and/or have any other desired angle relative to a substantially planar base member 108. In a stowed position, a side plate 114 can be lowered to lie substantially parallel to and adjacent to the top surface of a substantially planar base member 108.

In the embodiment depicted, a cart 100 can comprise two side plates 114, one on each side, that can extend along a substantial portion of the length of a substantially planar base member 108, and which can have a substantially rectangular geometry. In other embodiments, side plates 114 can have any other known and/or convenient lengths and/or geometries.

FIG. 1b depicts a top view of a cart 100, showing side plates 114 in a stowed position. As illustrated, side plates 114 can have dimensions and geometries such that in a stowed position they do not overlap. In other embodiments, side plates 114 can have any other known and/or convenient dimensions and/or geometries and/or can overlap.

The bottom surface of a substantially planar base member 108 can be coupled with at least one wheel assembly 104. As depicted in FIG. 1, a wheel assembly 104 can comprise a wheel 120, which can be coupled with a tire 122. A wheel 120 can be also coupled with a support mechanism 124. In FIG. 1, a support mechanism 124 for a front wheel 120 can be a swivel caster mechanism that can be coupled proximate to the front end of a bottom surface of a substantially planar base member 108. In FIG. 1A, a support mechanism 124 for a plurality of rear wheels 120 can be an axle assembly that can be coupled proximate to the rear end of a bottom surface of a substantially planar base member 108. In some embodiments, an axle assembly can support two wheels 120 simultaneously or each wheel 120 can have a separate axle. Wheels 120 and/or support mechanisms 124 can be comprised of aluminum, steel, iron, plastics, and/or any other known and/or convenient material or combination of materials. Wheels 120 can be substantially the same size, or can have different diameters as shown in FIG. 1. Tires 122 can comprise rubber, steel, nylon, or any other known and/or convenient material or combination of materials. Furthermore, tires 120 can be filled with foam, air, or any other known and/or convenient substance.

As depicted in FIG. 1, a frame assembly 102 can be coupled with a handle assembly 106. A handle assembly 106 can comprise at least one elongated member 126 that can be coupled with a frame assembly 102. In the embodiment depicted in FIGS. 1 and 1b, an elongated member 126 can be coupled with the front end of a substantially planar base member 108 via a hinge mechanism 128, which allows an elongated member 126 to rotate about an axis substantially perpendicular to the longitudinal axis of a substantially planar base member 108 for ease of use and storage purposes. In other embodiments, an elongated member 126 can be coupled with a frame assembly 102 via a sliding track mechanism, ball-and-socket, or any other known and/or convenient method.

As shown in FIG. 1b, an elongated member 126 can be substantially T-shaped, but in other embodiments an elongated member 126 can have any other known and/or convenient configuration. In some embodiments, an elongated member 126 can telescopically collapse for storage purposes. In other embodiments, an elongated member 126 can have pins and/or any other known and/or convenient mechanism whereby an elongated member 126 can temporarily lock into one of several desired lengths, thereby ergonomically accommodating persons of different stature. In yet other embodiments, an elongated member 126 can be selectively removable from a cart 100.

In some embodiments, an elongated member 126 can be stowed underneath a substantially planar base member 108 via a bracket mechanism 136. In other embodiments, an elongated member 126 can be stored above or within a substantially planar base member 108, and can be temporarily secured to a frame assembly 102 via any other known and/or convenient mechanism. An elongated member 126 can be made of metal, plastic, wood, polymer, and/or any other known and/or convenient material.

At least one portion of an elongated member 126 can be coated with insulating and/or non-slip material to prevent extreme temperatures from damaging a user's hand and/or to prevent slippage due to sweat or other slick conditions. In some embodiments, the surface of an elongated member 126 can have ridges or protrusions, but in other embodiments the surface can be smooth or can have any other known and/or convenient surface characteristics.

In some embodiments, the present device can further comprise at least one double-handle assembly 130. As shown in FIG. 1b, a double-handle assembly 130 can comprise a pair of substantially parallel elongated members 132, each having a proximal end and a distal end. A pair of substantially parallel elongated members 132 can be connected at a point near the proximal ends by a substantially perpendicular cross-member 134. As shown in FIG. 1b, the proximal ends of a pair of substantially parallel elongated members can symmetrically flare outward to a width wider than the length of a substantially perpendicular cross member 134 or remain substantially the same distance as the length of a substantially perpendicular cross member 134. In alternate embodiments, the proximal ends of a pair of substantially parallel elongated members 132 can symmetrically flare inward to a width narrower than the length of a substantially perpendicular cross member 134.

As shown in FIG. 1, a double-handle assembly 130 can be stowed underneath a substantially planar base member 108 and held proximal to the lower surface of a substantially planar base member 108 via brackets 136, or any other known and/or convenient device.

FIG. 1c depicts a longitudinal cross-sectional view of the device. In the embodiment depicted in FIG. 1c, the side plates 114 can be pivotally coupled with the frame assembly 102 via an open hinge mechanism. In the embodiment depicted in FIG. 1c, the open mechanism can be integrated into the frame assembly 102 and the side plates 114. As shown in FIG. 1c, the side plates 114 can be configured to have a concave arced configuration 138 along some or all of the edge of the side plate 114 proximal to the frame assembly 102. The frame assembly 102 can have protrusions 140 adapted and configured to selectively mate/couple with the concaved portion of the side plate 114. In some embodiments, the protrusions can be continuous along the device and/or can be intermittent. In operation, the side plates 114 can be configured the configuration depicted, can be deployed by pivoting the side plates about the protrusions 140 and/or can be removed.

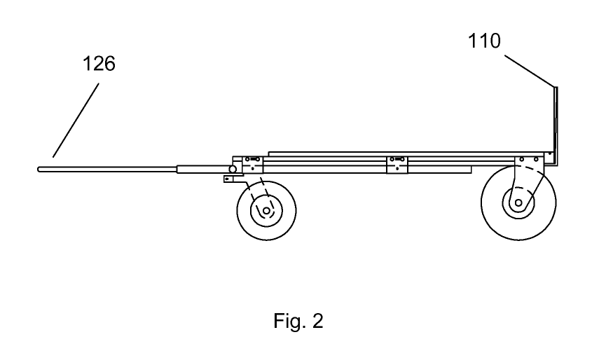

A cart 100 can be adapted to switch between multiple configurations depending on its intended use. FIG. 2 depicts a cart 100 in a dolly/hand truck configuration. A cart 100 can stand on a back plate 110 and an elongated member 126 can extend outward with respect to the longitudinal axis of a frame assembly 102. In some embodiments, an elongated member 126 can temporarily lock into place for added stability when transporting large and/or heavy objects. In use, a user can slide or place an object onto a back plate 110 and subsequently tip a cart 100 such that at least one rear wheel/tire 120 122 comes into contact with the ground surface. A user can then roll a cart 100 to its desired endpoint, with the object securely resting on the top surface of a frame assembly 102 during transportation.

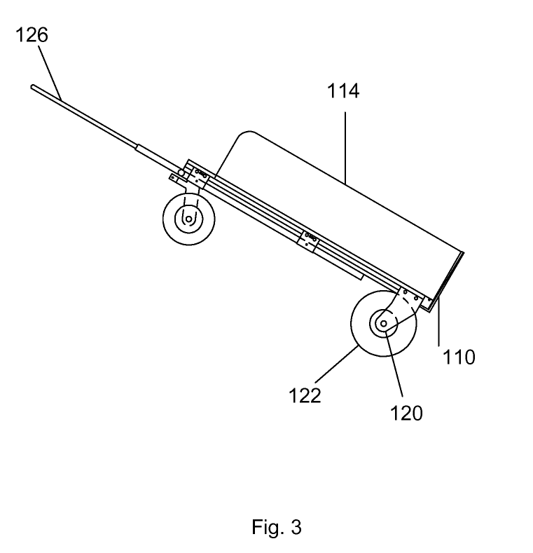

As shown in FIG. 3, a cart 100 can also be configured for use as a wheelbarrow. A plurality of side plates 114 can be extended and locked into place to properly retain any items that a user transports. A back plate 110 and an elongated member 126 can also be in extended, in-use positions. In some embodiments, a user can freely move and adjust an elongated member 126 for steering purposes. In use, a cart 100 can be filled with mulch, plants, or other materials for which a wheelbarrow is needed, and subsequently rolled to a desired location. In FIG. 3, a cart 100 can travel on only the rear wheels/tires 120 122, but in other embodiments, a cart 100 in a wheelbarrow configuration can be rolled on all wheels/tires 120 122.

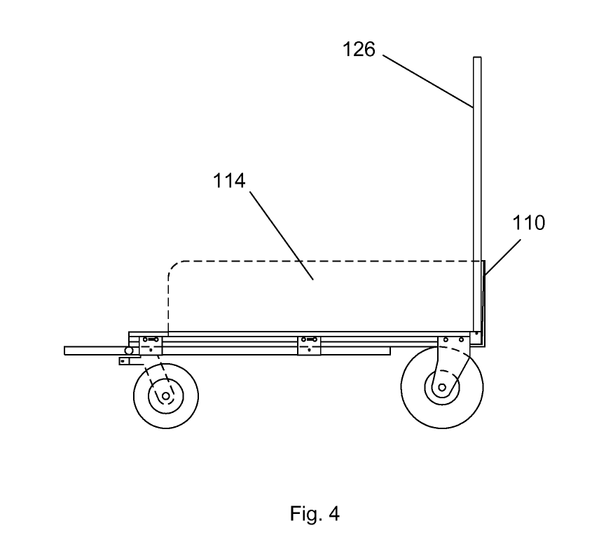

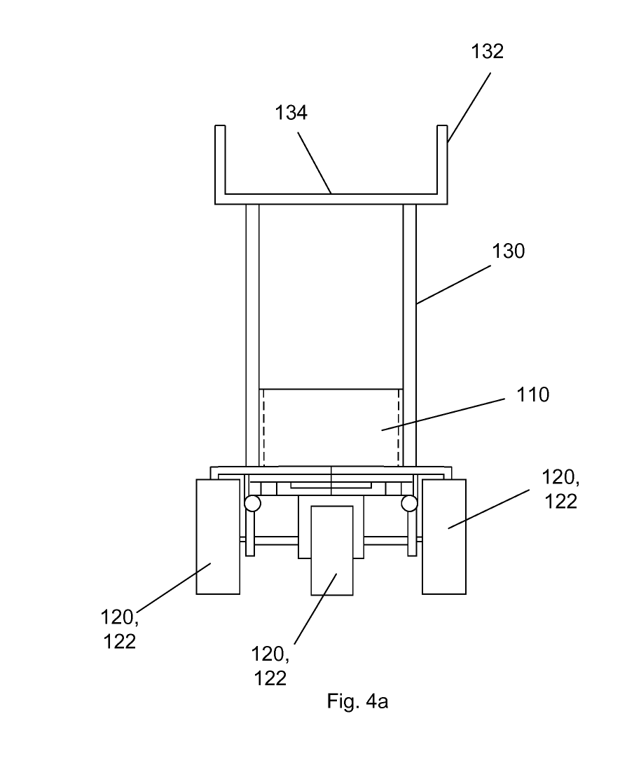

FIG. 4 depicts a cart 100 in a push-cart configuration. The back end of a frame assembly 102 can be coupled with an elongated member 126 that can be secured in a substantially orthogonal position relative to a substantially planar base member 108, and can be substantially parallel to an extended back plate 110 when in use. In some embodiments, a plurality of side plates 114 can also be extended. FIG. 4a illustrates a front view of the embodiment shown in FIG. 4. In this embodiment, an elongated member 126 has a different design than an elongated member 126 in the embodiment of FIG. 1. In FIG. 4a, double-handled assembly 130 is shown in a deployed position, which can provide multiple gripping surfaces and/or surfaces off which items can be hung. In use, items can be loaded onto a substantially planar base member 108 and a user can subsequently push a cart 100, via a double-handled assembly 130, in a forward direction as represented by the arrow in FIG. 4. In embodiments where wheels 120 are coupled with casters as wheel support mechanisms 124, a user can push a cart 100 in any other convenient direction.

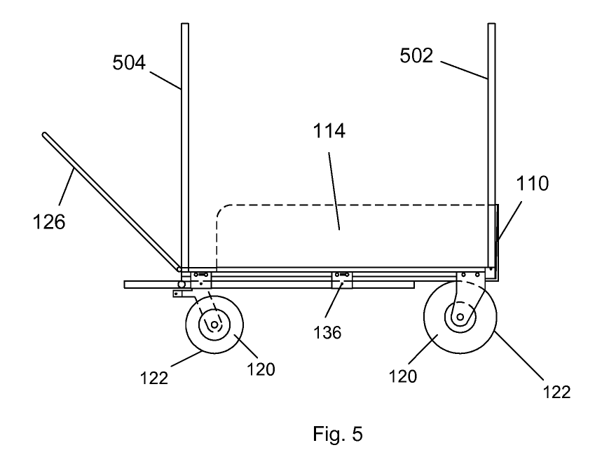

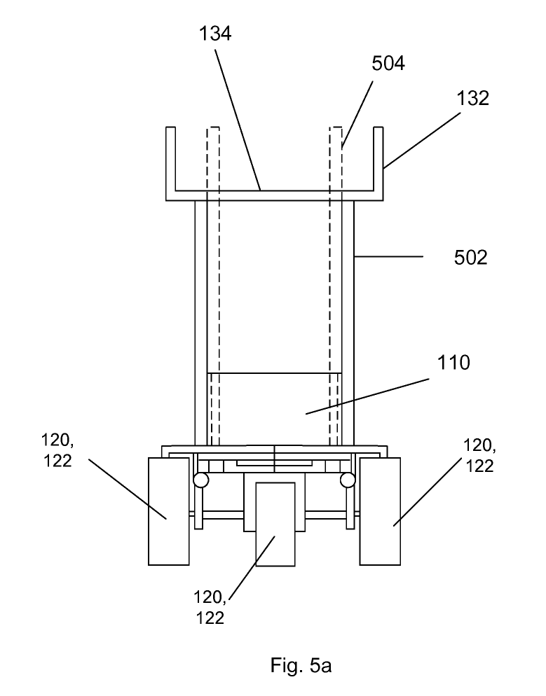

As shown in FIG. 5, a cart 100 can be configured for use as a pull-cart and can be used to transport lumber or other building materials. FIG. 5 depicts the configuration shown in FIG. 4, but with additional handle members. An elongated member 126 can be coupled with the front end of a cart 100 and can be moveable when in use for steering purposes. A first additional handle member 502 can be locked into place at the rear of a cart 100, as explained above. Additionally, a second additional handle member 504 can be coupled with the front end of a cart 100 and an be locked in a substantially orthogonal position relative to a substantially planar base member 108. In some embodiments, additional handle members 502 504 can be a double-handled assembly 130, which can be stowed proximal to the lower surface of a substantially planar base member 108.

In this configuration, a user can haul lumber by resting the wood across horizontal support bars of both handle members 502 504. A user can then pull a cart 100 via an elongated member 126. In other embodiments, this pull-cart configuration can be used in any other known and/or convenient manner.

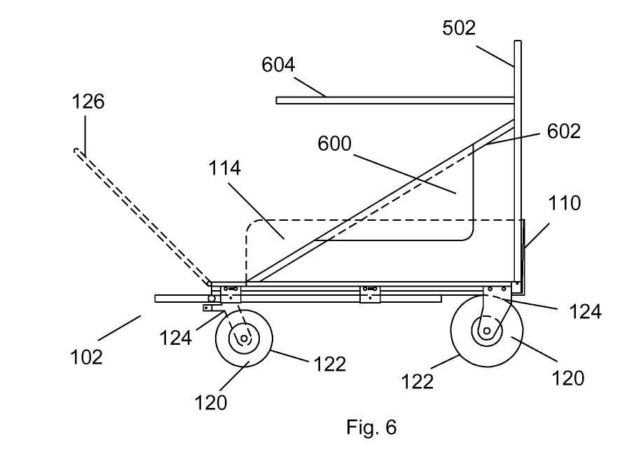

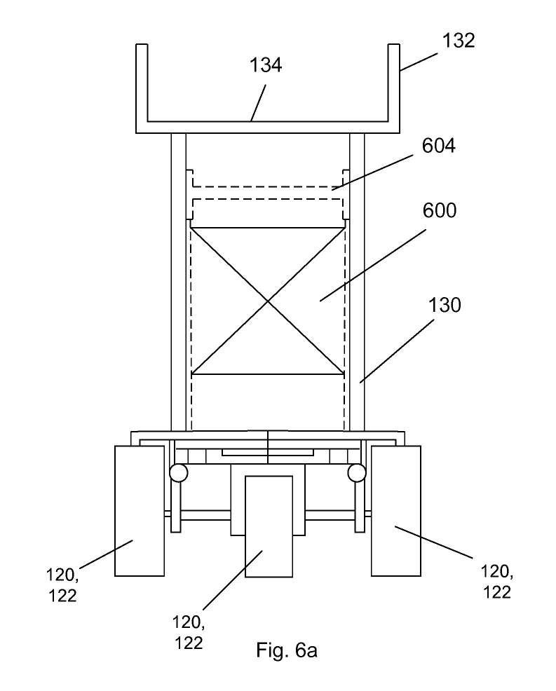

In some embodiments, a cart 100 can be converted into a stroller configuration, as depicted in FIG. 6. A cart 100 can have removable stroller accessories, including a child seat 600 and a child seat support 602. A child seat 600 can be made of cloth, plastic, or any other known and/or convenient material to support a child. In the embodiment shown, a child seat 600 has a substantially triangular geometry when viewed from the side. However, in other embodiments a child seat 600 can have any other known and/or convenient geometry. A child seat support 602 can comprise a set of parallel rod members, as illustrated in FIG. 6a, the ends of which can be operatively coupled with a frame assembly 102 and first additional handle member 502, as shown in FIG. 6a. In the embodiment shown, the rod members of a child seat support 602 can pass through tubular openings in a child seat 600 to support a child seat 600. In alternate embodiments, a child seat 600 and a child seat support 602 can be coupled via straps or any other known and/or convenient mechanism.

In some embodiments, and as shown in FIG. 6, a cart 100 can further comprise a removable shade member 604 in order to block harmful sun rays, rain, and/or snow from a child when a cart 100 is in use as a child's stroller. A shade member 604 can be coupled with an additional handle member 502, as shown in FIG. 6, or can be coupled with a child seat support 602 in any convenient manner. In use, a cart 100 in a stroller configuration can be either pushed, via additional handle member 502, or pulled, via a additional handle member 504 that can be coupled with the front end of a frame assembly 102.

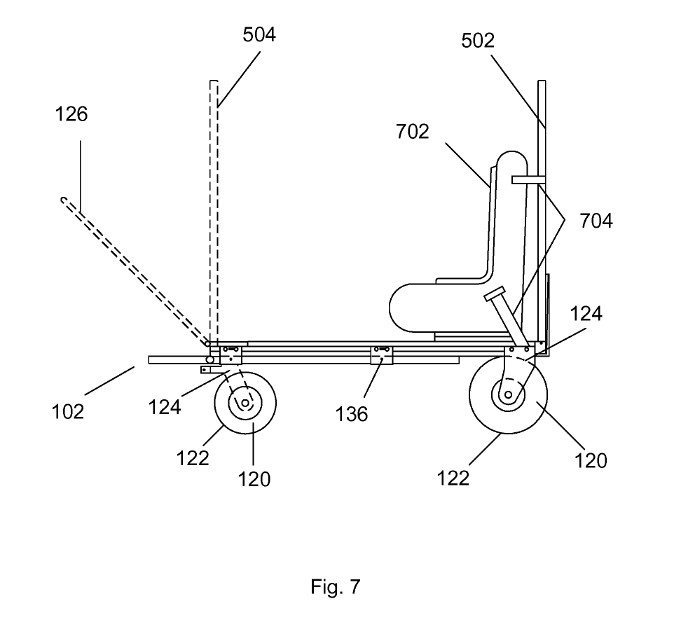

Referring to FIG. 7, in some embodiments a cart 100 can be configured for use with a child's car seat. As depicted, a child car seat 702 can be secured to a cart 100 via straps 704, but in other embodiments a child car seat 702 can be secured to a cart 100 in any other known and/or convenient manner. In the embodiment shown, a user can push or pull a cart 100 in the manner described above for push- or pull-cart configurations. In addition to a child car seat 702, additional items can be transported via the portion of a substantially planar base member 108 that is not occupied by a car seat 702.

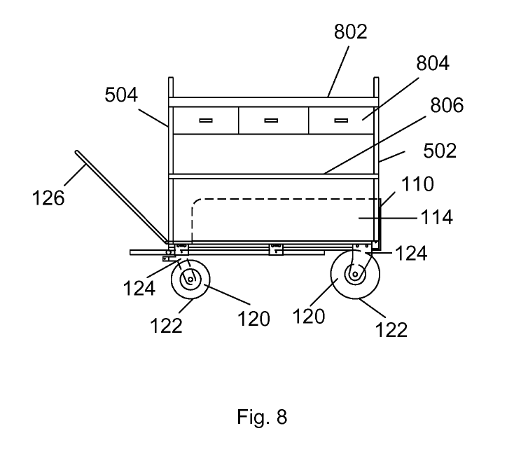

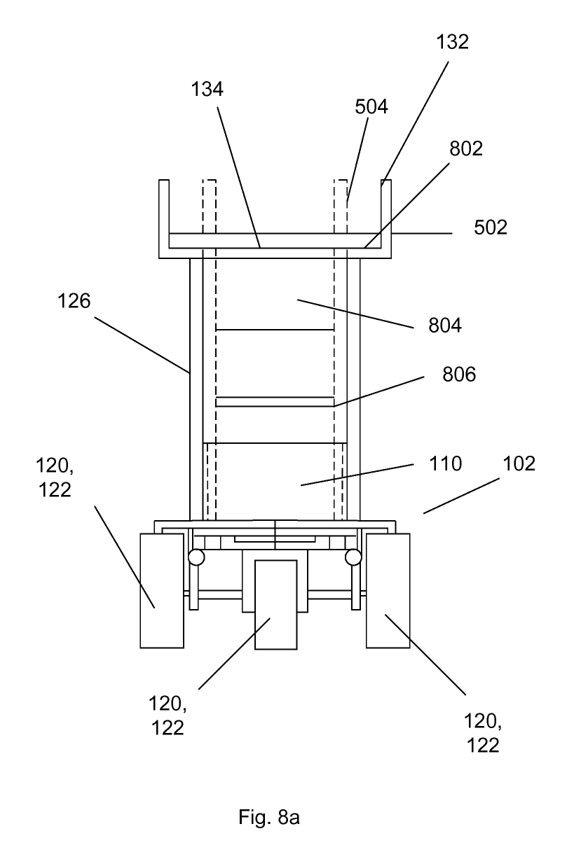

A cart 100 can have additional accessories so that it may be used as a moveable kitchen/utility cart. As shown in FIG. 8, additional handle members 502 504 can be used to support a butcher block 802, set of drawers 804, and/or shelf 806. FIG. 8a depicts these additional elements from a rear view perspective of a cart 100. In some embodiments, a cart 100 in this configuration can be used as a bar, tool cart, worktable, garden cart, office cart, or can have any other known and/or convenient use.

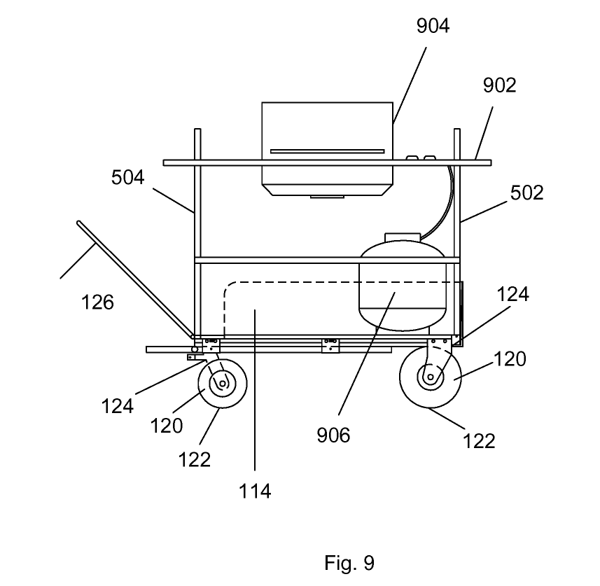

In yet more alternate embodiments, a cart 100 can be used as a grill cart, as shown in FIG. 9. In addition to additional handle members 502 504, a cart 100 can further comprise a horizontal grill support 902 for supporting a grill 904. In the embodiment shown, a grill support 902 can be coupled with additional handle members 502 504 and can comprise an aperture large enough to accommodate the bottom of a grill 904 while allowing the top of a grill 904 to sit above the grill support 902 surface. In other embodiments, a grill 904 can be supported by a grill support 904 in any other known and/or convenient manner. A substantially planar base member 108 can hold a gas tank 906 for use with a grill 904. In some embodiments, a plurality of side plates 114 can be extended to further secure a gas tank 906. A cart 100 can further comprise an elongated member 126 as an additional way to move a cart 100.

In the embodiments described above, a user can easily manipulate components of a cart 100 in order to switch between each configuration. Thus, in use a cart 100 can be used for one purpose and subsequently converted to a different configuration for another purpose. Moreover, one or more of each component described above can be selectively removable from a cart 100. In some embodiments, one or more of each component described above can be permanently coupled with a cart 100 via welding, ultrasonic bonding, or any other known and/or convenient method of permanent bonding.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A multi-use cart comprising:
a substantially planar base member having a top side and an underside.
at least one wheel assembly connected to the underside of said substantially planar base member, wherein said wheel assembly further comprises a wheel and a support structure;
at least one elongated member having a proximal end and a distal end, and wherein the distal end is removably connected to a point on said substantially planar base member;
a back plate, wherein a lateral edge of said back plate is connected to an end of said substantially planar base member;
at least one side plate, wherein a lateral edge of said side plate is connected to a lateral edge of said substantially planar base member;
at least one double-handle assembly;
a set of brackets connected to the lateral sides of said substantially planar base member, wherein said brackets selectively engage with said double-handled assembly and hold said double-handled assembly proximal to the underside of said substantially planar base member.

2. The device of claim 1, wherein said back plate and said at least one side plate are connected to said end and said lateral edge of said substantially planar base member via a hinge device.

3. The device of claim 2, wherein said hinge device is a ball hinge.

4. The device of claim 3, wherein said substantially planar base member further comprises a set of substantially parallel running substantially along the lateral edges of said substantially planar base member.

5. The device of claim 1, wherein said support structure for at least one wheel assembly is selected from the group consisting of: a caster mechanism, an axle mechanism.

6. The device of claim 1, wherein the proximal end of said elongated member terminates in a substantially perpendicular member.

7. The device of claim 1, wherein said wheel assembly further comprises a tire.
